(19) United States
(12) Patent Application Publication
(10) Pub. No.: US 2004/0177742 A1
(43) Pub. Date: Sep. 16, 2004

(54) Device for stringed instruments

(76) Inventor: Gregory Michael Orme, Brisbane (AU)

Correspondence Address: Horace Crater, 310 Oakwood Cove, La Vergne, TN, 37086-4130, US

(21) Appl. No.: 10/451,468

(22) PCT Filed: Dec. 24, 2001
(86) PCT No.: PCT/AU01/01661

(30) Foreign Application Priority Data
Dec. 28, 2000 (AU) PR 2342
Jan. 11, 2001 (AU) PR 2494
Mar. 15, 2001 (AU) PR 3732
Apr. 26, 2001 (AU) PR 4612
Aug. 21, 2001 (AU) PR 7133
Sep. 11, 2001 (AU) PR 7582
Sep. 13, 2001 (AU) PR 7629
Sep. 20, 2001 (AU) PR 7793
Oct. 29, 2001 (AU) PR 8533
Nov. 19, 2001 (AU) PR 8956
Dec. 12, 2001 (AU) PR 9447

(51) Int. Cl. G10D 3/06

(52) U.S. Cl. 84/314 R

(57) ABSTRACT

A device (10) for a stringed instrument comprising at least one moveable support having a top surface which is adapted to abut a string between its fixed ends and is able to be moved to abut the string at a different position to thereby create a sound of a different frequency when the string is vibrated. Also disclosed are: a method for controlling polarisation of electromagnetic radiation; a device for receiving and transferring visible light comprising an array of coupled lenses separated by barrier means; a method of searching data on the Internet; a system for compressing data and a method of modelling data particularly spoken sound (compressing data by modelling part of the data and adding additional information to create the original or near original data); a device for processing data; the protection of vehicles involved in accidents; the precise movement of objects by a magnetic field within a body.

The device may include a control means for controlling where the top surface abuts the string along its length.

The control means may comprise a lever operable by a finger.

Preferably the control means comprises a sliding means which is adapted to slide the top surface forward or backward along part of the length of the string.

Preferably the control means comprises pivot means which is adapted to pivot the top surface whereby a different abutment surface is able to abut the string.

The control means may comprise an urging means for urging an abutment surface into contact with the string.

Preferably the urging means comprises a plurality of springs adapted to urge a different abutment surface into contact with the string.

The control means may include a different control member for each abutment surface, whereby each control member can be operated to raise or lower the abutment surface into or out of contact with the string.

It is preferred that each embodiment can be used in relation to a plurality of strings.

Preferably the abutment surface comprises a movable fret.

The device may comprise a base which is adapted to be attached to a neck or soundboard of a stringed instrument.

The device may comprise a sleeve with a plurality of supports extending upwardly from a top surface of the base and acting in a similar fashion to frets.

It is preferred that the device comprises a plurality of sliding portions which are independently slidable over the top surface of the neck of the stringed instrument, with each slidable portion having an abutment surface associated therewith.

The device may form part of the musical instrument such as a neck.

It is preferred that the movable support is able to be twisted to permit the abutment surface to contact the string.

Preferably the device is able to be moved when at least one string has been vibrated in order to change the frequency of the sound produced by the or each string from its initial frequency when first vibrated.

Preferably the device includes buttons to move each abutment surface.

The device may include pressurised areas which when individually depressed are adapted to move at least one abutment surface.

The abutment surface may be flat or pointed on top of a support post.

Alternatively at least one abutment surface may be specially configured to change the reverberation time of a string when it is plucked.

Preferably at least one of the abutment surfaces includes a damping means for applying a predetermined amount of damping to a string which has been vibrated.

According to one embodiment the damping means may completely damp any sound from that string.

The words “comprising, having, including” should be interpreted in an inclusive sense, meaning that additional features may also be added.

### BRIEF DESCRIPTION OF THE DRAWINGS

Preferred embodiments of the present invention will now be described by way of example only with reference to the accompanying drawings in which:

FIG. 1 shows a schematical view of a guitar according to a first embodiment of the present invention;

FIG. 2 shows a neck of a guitar according to a second embodiment of the present invention;

FIG. 3 shows a neck of a guitar according to a third embodiment of the present invention;

FIG. 4 shows a neck of a guitar according to a fourth embodiment of the present invention; and

FIGS. 5a and 5b show a schematical representation of a neck of a guitar according to a fifth embodiment of the present invention.

### BEST MODE FOR CARRYING OUT THE INVENTION

It should be understood that the present invention for simplicity has been described having regard to a guitar. However it is equally applicable to other types of instruments incorporating strings.

The embodiments described hereinafter relate primarily to raising and lowering of frequency of vibration of strings and other effects on stringed musical instruments. By using devices in accordance with the present invention the operator or player of musical instruments is able to modulate the frequency of sounds produced.

When playing a guitar it is often desirable to bend strings to one side so as to increase the frequency of notes played. It would also be desirable to decrease the frequency of notes played.

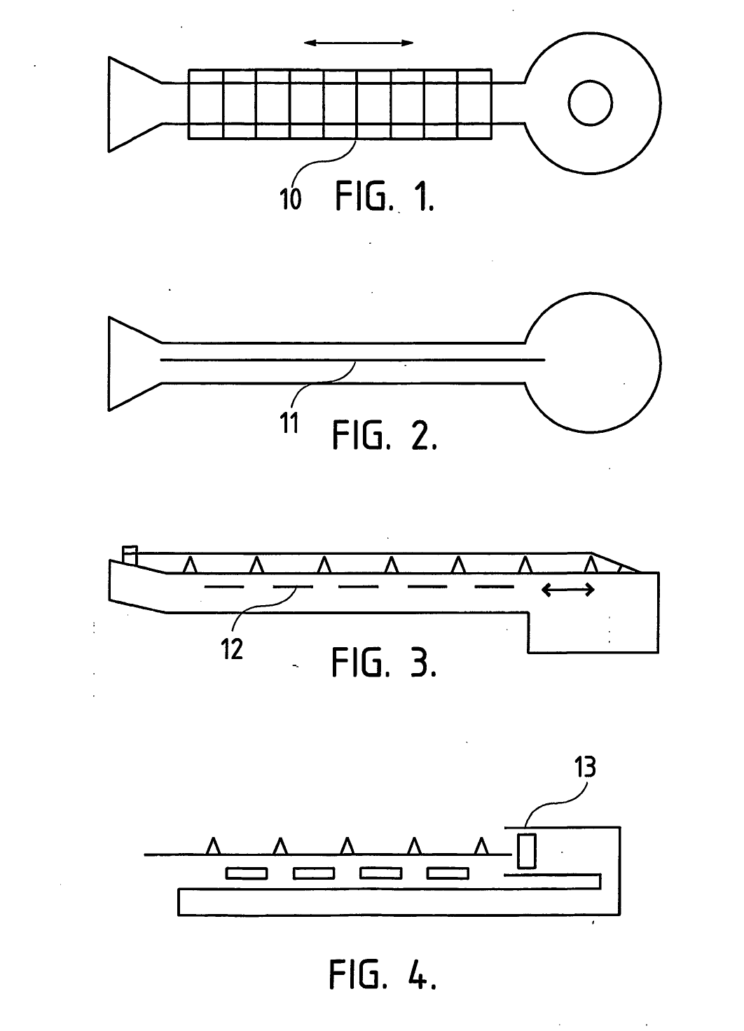

According to the first embodiment of the present invention the frequency of music produced by a guitar is changed by moving the frets of the neck to a different position on the neck by action of some input. Thus as shown in FIG. 1 the frets may be formed on a separate device 10 which is located over the neck of the guitar.

This device would be in the form of a sleeve having a series of fret-like members located along its length. In appearance these members may look like a ladder.

The device 10 could be located underneath the strings and may be played as if the members on this device were fixed frets. Therefore if a cord was played for example the device could be moved up or down the neck to change the frequency of the sound produced by playing the cord.

The sleeve may be supported on wheels or guides which fit into corresponding guides on the neck of the guitar.

The sleeve could be moved by many mechanisms, for example by pressing on the neck between the frets.

There may also be parts located on the underside of the neck which input a signal by way of buttons to make the sleeve move.

As shown in FIG. 2 a chamber of fluid may be provided along the length of the neck as shown by item 11.

When buttons between the frets are pushed down on this chamber, it is able to expand at another location to thereby move a fret member into contact with one or more of the strings and therefore produce a sound of a different frequency.

Buttons 12 could be located between each fret as shown in FIG. 3.

According to another variation buttons might have a mechanism so that pushing different ones make the sleeve move different distances, for example, corresponding to an equal fraction of a semitone.

The buttons may also have different sizes so that, pushing different buttons displaces a different amount of fluid and therefore moves a member a different distance so that its contact surface contacts a string at a different position.

It is preferable that at the end of the hydraulic chamber there would be a mechanism so that pressing the buttons makes the sleeve move up the neck as shown in FIG. 4.

According to another variation pushing down on buttons causes fluid to make the piston 13 move and hence the sleeve to move to the left. As a button is released, springs could be used to make the sleeve move back down the neck.

According to another variation a fret like object can be placed on the sound board or other parts of the instrument and moved by some mechanism. This may have rollers on its surface in contact with the strings so when moved there is less noise.

According to another variation the guitar could be specially designed so that its neck direction can be changed.

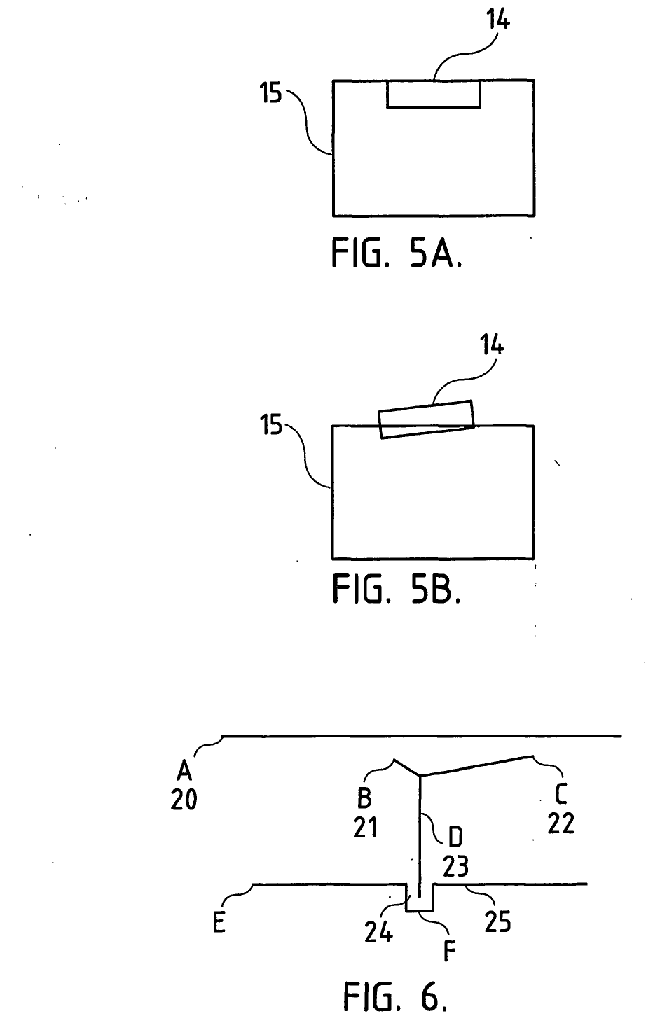

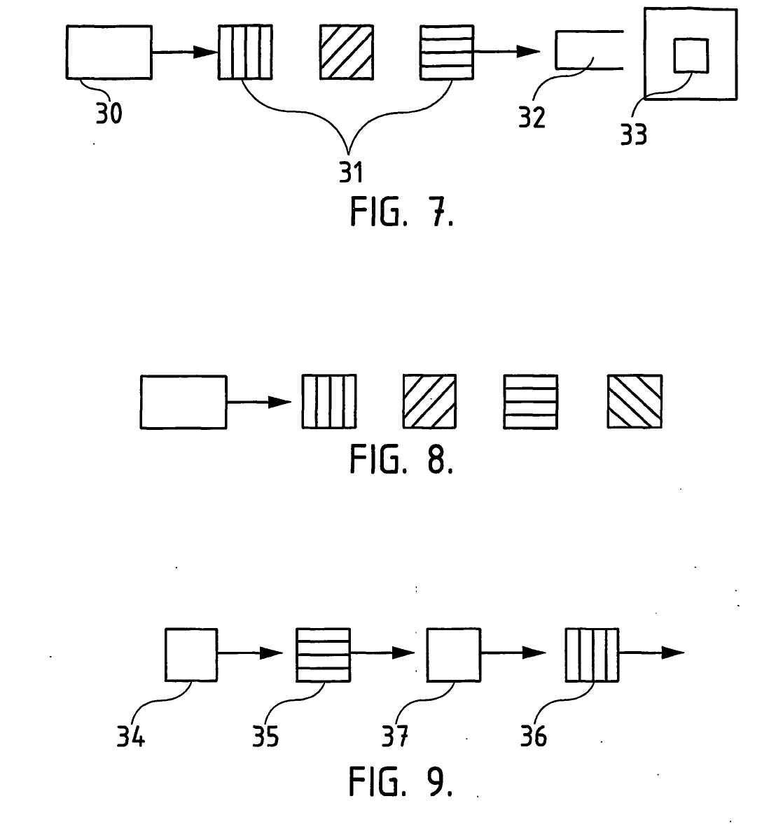

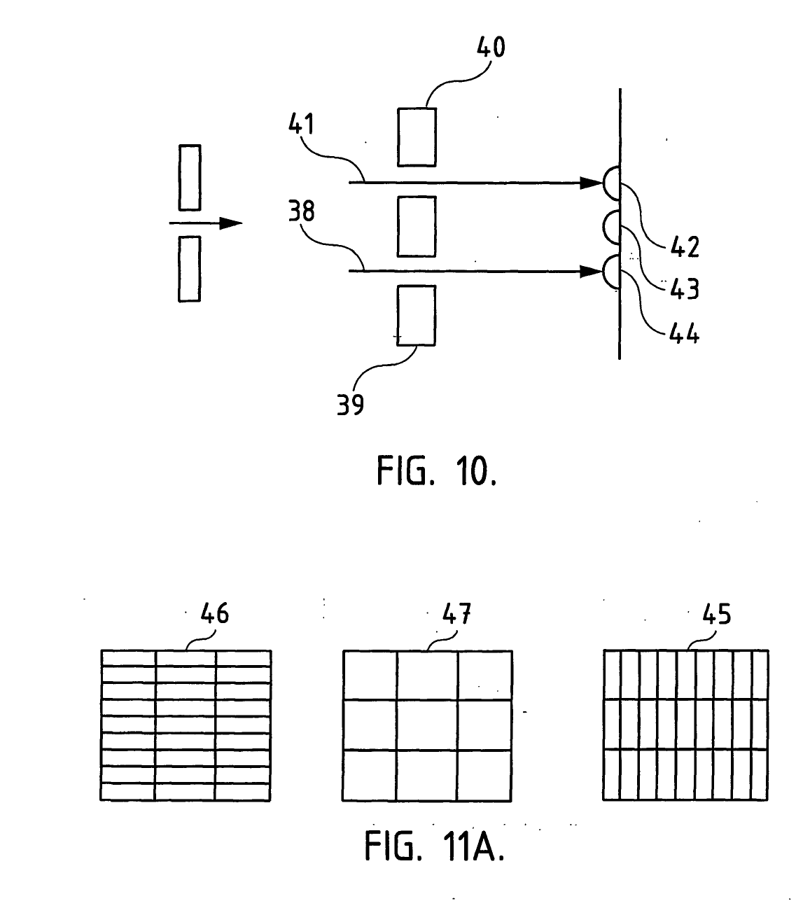

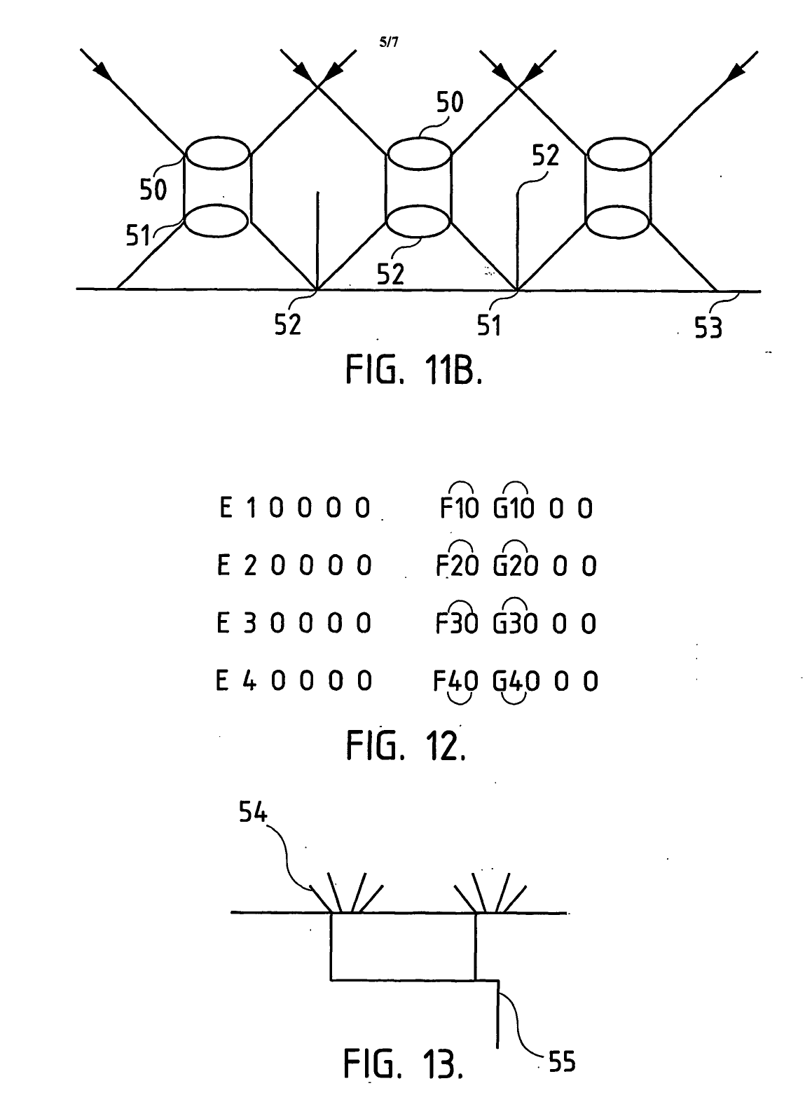

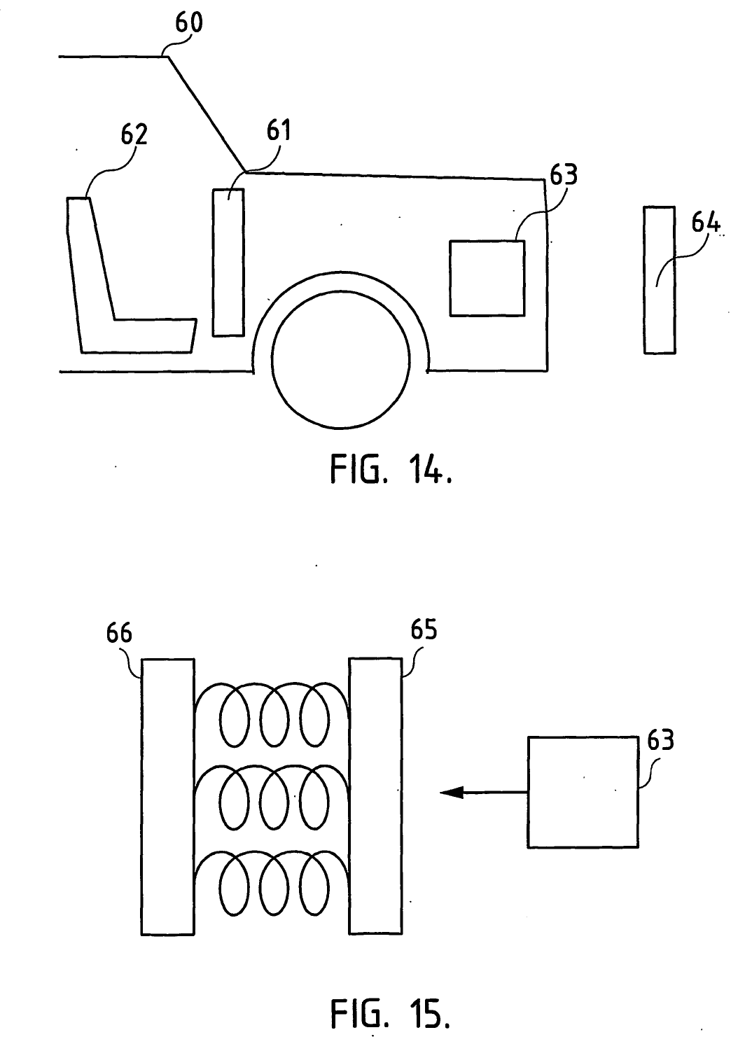

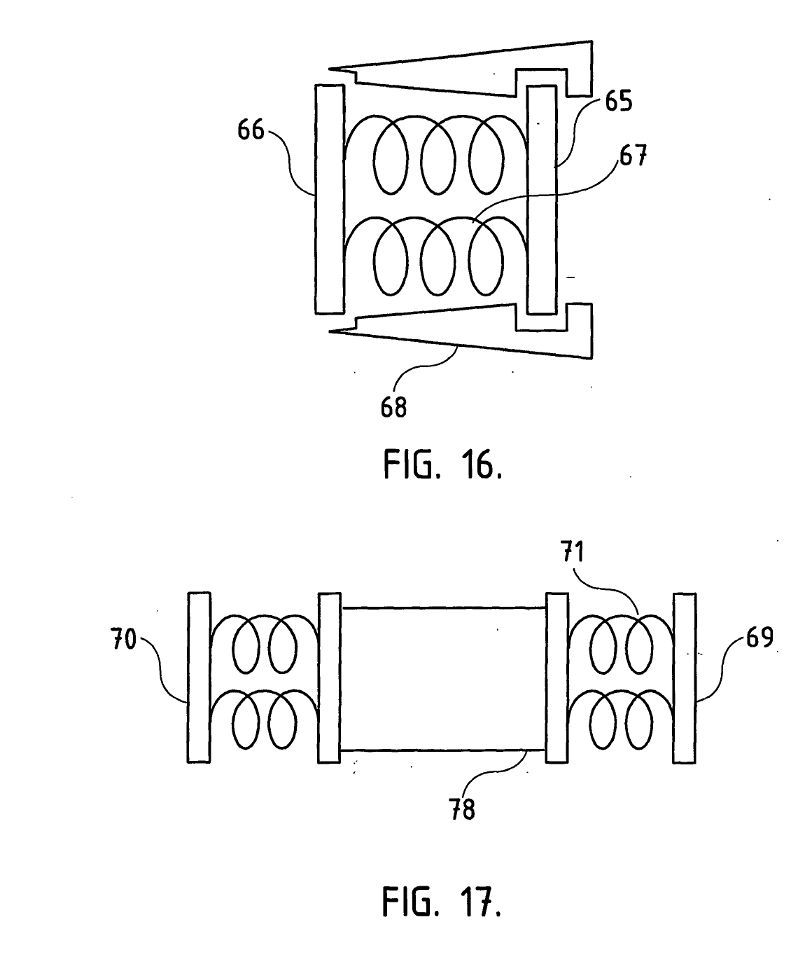

As shown in FIG. 5a the neck 14 may be located in a rebated area in a body 15.

By twisting the neck as shown in FIG. 5b it may make it easier to play certain chords of the guitar.

It is preferable that such a neck would be retractable so that it could be adjusted by the player.

In addition the fixing points of the string would also need to move with the rest of the neck.

According to another embodiment of the present invention a sleeve or similar device with members in the form of frets located thereon is attached at each end to some form of control means such as springs.

It is preferable that movement of the sleeve or similar device requires a predetermined amount of pressure by the player to ensure that the device does not move too easily if this is not required.

The sleeve device may also have a number of different stopping positions which correspond to particular sounds or notes which may be required.

According to another embodiment whammy bar like devices can be attached.

Normally on a guitar a whammy bar when moved moves the strings tighter or looser, hence changing the frequency of notes played. A similar handle or button etc could be used to make the sleeve move up and down the sound board or other parts of the instrument.

According to a further embodiment of the present invention each member on the sleeve is in the form of a vertical post or wall which has a number of different contact points on it which are able to contact a string when the support is moved. As an example a lever may be operated by a finger to change which contact point contacts the string.

In this example it may be possible to have support posts located in the neck of the guitar.

As shown in FIG. 6 a string 20 on a guitar or other musical instrument is located above a fret 21 which may be of any standard shape.

A piece of material 22 which may be pushed down and move fret 21 to the right is able to change the frequency of a note being played.

The fret 21 extends in this example upwardly at an angle away from a vertical support 23 which may be made of a bendable material. This support is fixed into a slot 24 formed in the top surface of the neck 25. By pressing down on the lever 21 the support is able to bend and this enables contact between the fret 22 and the string 20.

According to another invention of the present application a method is provided for controlling circular polarisation of electromagnetic radiation such as visible light. Typically light can be polarised by directing it through polarising filters. The present invention aims at utilising a new technique to control the polarisation of light and other electromagnetic radiation.

According to the invention there is provided method of changing the circular polarisation of electromagnetic radiation comprising the steps of providing a transmitter of circularly polarised electromagnetic radiation, providing a controller to control the circular polarisation of electromagnetic radiation, directing circularly polarised electromagnetic radiation past the controller and operating the controller to change the circular polarisation of the electromagnetic radiation.

Preferably the controller is adapted to alter the speed of the circular polarisation.

The controller may be adapted to control the rotational speed of the electromagnetic radiation.

The controller preferably includes a generator for generating a magnetic field.

Preferably the generator comprises a conductor carrying an electrical current.

Preferably the controller includes a driving means for moving the conductor.

It is preferred that the driving means is adapted to rotate the conductor.

It is preferred that the controller has at least two modes of operation, a first mode where the conductor is rotating and a second mode where the conductor is stationery and not carrying an electric current.

Preferably the controller is adapted to switch the polarised electromagnetic radiation from a first state to a second state.

Preferably the controller is adapted to vary the rotational speed of the conductor to a plurality of different speeds.

It is preferred that the controller is adapted to switch the polarisation of electromagnetic radiation between a plurality of different polarised states.

According to another embodiment of the present invention the controller comprises a reflective surface.

It is preferred that the controller comprises a rotating electromagnetic field.

It is preferred that the controller comprises a conductor through which the electromagnetic radiation is adapted to be transmitted.

The method may include the step of generating the electromagnetic radiation from a rotating electromagnetic source such as a laser or diode.

The controller may comprise at least one filter.

Preferably the at least one filter is adapted to be rotatable at at least one speed.

According to a further aspect of the invention there is provided a method of energising a conductor comprising the steps of providing a transmitter of circularly polarised electromagnetic radiation, providing a rotating conductor, directing the polarised electromagnetic radiation from the transmitter in close proximity to the rotating conductor to induce a current flow in the conductor and utilising the current generated in the conductor to drive a device or to enable the current to be stored in a storage device.

Preferred embodiments of the present invention will now be described by way of example only.

According to the preferred embodiment light passing a rotating wire having an electrical current passing therethrough is effected to the extent that its circular polarisation changes. According to the preferred embodiment a switching device is provided which is able to rotate a wire and switch current to it when it is desired to alter the polarisation state of light passing the rotating wire.

The extent to which the light is polarised depends upon the speed of the rotating wire when it is energised with the current passing through it.

A preferred embodiment also contemplates a reverse arrangement in which circularly polarised light strikes an array of wires or other materials so that an electric current is induced in them by the beam. In this way a signal carried by light can be directly translated into electricity.

Thus as an example polarised light transmitted in an optical fibre may be adapted to pass through a coil of wires so that energy is converted to electricity which can be used in electrical circuitry.

Another embodiment uses circuits, particularly those executing Boolean Algebra statements such as AND, OR, and NOT that have additional inputs that can change their Boolean Algebra statement to another. For example by additional inputs a NOR junction could become an AND junction. By synchronising a number of external inputs circuitry could be reprogrammed to do different tasks.

Such circuits could be formed into nodes in a network where various nodes can request data and command other nodes in competitive and cooperative ways. Nodes in a network may be in a position where they are better suited to a task and so might win a competition from other nodes in carrying that out, and so lead to specialisation for tasks. Preferably such nodes would include circuitry and computers on the Internet. The operation of these nodes can be represented graphically with icons and tree like connections.

If the beam of light is modulated either in an on/off configuration, lower/higher amounts, or a change in circular or other polarisation such as a reversal of direction of polarisation (clockwise or anticlockwise) this can be transmitted and translated into digital on/off or analog variations in electrical signals.

According to another aspect of the invention altering the polarity of signals in optical circuitry can convey statements in Boolean Algebra. Instead of or in addition to on/off switching of light, for example switching vertical polarization to horizontal polarization may mean that the signal cannot go through a vertical polarization filter. Thus in this example switching the polarization is equivalent to switching the signal off, and a Morse code analogy of on/off signals is produced by switching the polarization between in this case horizontal and vertical.

By using this, circuits to derive any statement in Boolean Algebra can be made, just as on/off signals do in electrical circuitry. Switching of polarity may be done by electric, magnetic or other means with resulting circuits composed partially or wholly of optic fibres and altered by such switching.

As another aspect of the invention circuits of a processor or memory in a computer could be laid out with optic channels partially instead of electric circuits and inputs changing circuits by magnetically or by other means changing the polarization of light instead of turning a flow of electricity on or off. Such switching may be performed preferentially on some frequencies of light and not on others.

It can also be used to transmit power, in a similar way to power lines. Preferably this power can be used to give an alternative to wires, where electricity induces circular polarization in a beam, this beam is sent perhaps by optic fibre or through the air, and then the electricity is regained by inducing a current at the other end.

According to another embodiment of this invention a controller is used to alter the circular polarisation of a light beam on reflection or refraction against a surface of another medium. For example circularly polarised light striking the surface of one medium may be reflected with an increased speed of rotation.

According to another embodiment circularly polarised light is adapted to pass through a rotating or moving magnetic field. Light would pass between north and south poles of rapidly rotating magnets causing the circular polarisation speed to increase.

One analogy might be a motor where changes in the magnetic field cause the centre to turn. If there was no central part of the motor and a light beam shone through it, it would then become circularly polarised according to the speed of rotation of the motor.

As shown in FIG. 7 a circularly polarised beam of light generated by a rotating laser 30 is able to pass through a series of filters 31 that serve to increase the rotational speed of the polarisation by changing the orientation for example of the middle filter.

Altering the polarity varies as the light goes into optical fibres 32 then onto a display panel of various shapes. This display panel may have surface materials to polarise light and so this polarisation change may cause the light to become brighter or darker according to its orientation when it strikes those polarised materials 33.

According to one embodiment the speed of the rotating polarisation is able to be increased by having filters close together which incrementally change the angle of polarisation of light passing therethrough as shown in FIG. 8.

According to another aspect of this invention this circularly or elliptically polarized beam can also be used for cutting. As the beam strikes a surface there is a twisting force applied as the beam is rotating. This can be used to rotate objects and also to cut into them in a similar way to a rotating drill.

The present invention is also applicable to other forms of polarisation such as elliptical polarisation.

The manipulation of electromagnetic radiation for polarisation purposes is explained more clearly below with reference to the FIG. 9.

If for example one wishes to modulate a light beam from a device 34, polarising devices 35 and 36 may be utilised. They may be for example slits, polarisation materials or magnetic fields or any device which can either alter the polarisation of for example a beam of light or stop it or attenuate it as desired.

The device 37 is located between the two filters 35 and 36 and is in the form of a controller that can alter the polarising effects it has on for example a beam of light.

If for example the device exerts a magnetic or electric field that affects the polarisation of light (such as a rotating energised conductor) the only way a beam of light passing through filter 35 can also pass through filter 36 is if the controller 37 changes the polarisation of the light.

In FIG. 9 filter 36 represents a horizontal polarisation filter therefore controller 37 must change the polarisation of light so that it is able to pass through the vertical polarisation filter of filter 36. Accordingly the controller C is able to act as a switch which passes or blocks passage of the light emitted from laser 34.

If the controller 37 produces a magnetic field which alters the polarity of the light beam 34 to a 45° angle then it is able to pass through filters 35 and 36.

When the magnetic field is removed or attenuated the filter devices 35 and 36 become partially or wholly opaque to the light beam from laser 34.

In other embodiments of the invention a single filter 36 may be used. By using a weaker magnetic field or one that alters in various polarised angles it is possible to regulate the amount of light going through filter 36 to give a similar effect to a transistor. Thus modulating the magnetic field of the controller 37 can lead to a modulation of the light from laser 34, with this modulation perhaps for example being an electric signal giving an electricity to light converter of data.

In other variations an electric potential may be used at controller 37 to modulate the polarity of filter 36.

Another example of the invention is shown with regard to FIG. 10 in which devices 40 and 39 refer to slits which allow passage of beams 41 and 38 therethrough. Filters 39 is vertically polarised and filter 40 is horizontally polarised. Light passing through the above filters fall on receptors 42, 43, 44. If two beams are both allowed through of the same polarity then perhaps receptors 42 and 44 would record no light as destructive interference of the two beams might result in no signal being received by those receptors. Receptor 43 may receive a signal by constructive interference.

By modulating beam 38 the receptors may pick up modulated signals. Say beam 41 is much stronger than beam 38 then receptor 43 might pick up a signal strongly of beam 41 and with a modulated beam 38 adding to it, light an optical transistor.

In another example with a modulated beam 41, receptor 42 may pick up a varying signal as well which is perhaps stronger than the modulated input beam 38.

According to another variation a device like a liquid crystal can be created. For example if a pixel is coloured red, light from behind it is polarised at a certain angle by say a magnetic field so that it is partially or wholly blocked from going through the red pixel as it itself is polarised to a certain angle.

By utilising modulation like this various arrays of circuits can be built. For example logic circuits where beams are modulated to alter their polarity by various means, even by sound.

In another example defraction can be employed to modulate a beam.

Arrays of pixels are shown in FIG. 11A on a display screen 45. Light is able to pass through an initial array that converts the light into for example horizontal polarisation at filter 46 through controller 47 and in device 45 it is set to vertical polarisation.

Device 47 exerts a change of polarity perhaps by magnetic fields in say each grid square which alters the light beam polarity to vary its passage through the various RGB pixels of device 45. In other variations an electric current may be used to alter the polarity at device 47.

According to another variation of the invention polarisation may be used to vary an electrical or other response.

A beam of light may be directed through a polarising device to a grid of wires or organic chains of molecules, etc. This grid would register an electric current if light of a certain polarity strikes it. The polarising device can then vary the polarity and hence vary the current in the receiving device, thus functioning as a switch or other device.

According to another inventive aspect of the present invention there is provided a device for receiving electromagnetic radiation. The device is particularly concerned with receiving visible light and transferring it to a display means.

According to a preferred embodiment of the present invention the device is intended for forming pixels.

According to the present invention there is provided a device for receiving and transferring visible light comprising an array of coupled lenses, each comprising first and second lenses aligned to focus light passing therethrough onto a receiving means and a plurality of barrier means separating adjacent coupled lenses so that light passing through a lens of one coupled lens cannot pass through a lens of adjacent coupled lenses.

It is preferred that the receiver means comprises a surface or a display.

Preferably the device includes controlling means for controlling the distance of one lens from another in a coupled lens.

It is preferred that the first lens in the coupled lenses is larger in diameter than the second lens.

Preferably the first lens receives light before the second lens.

The lenses in a coupled lens are preferably aligned along a common focal plane or axis.

Preferably each coupled lens forms a pixel on the receiver means.

The receiver means may comprise one or more receptors of electrical sensors which receive the light transmitted through the coupled lenses.

Preferably the coupled lenses are arranged in a tube.

Preferably each of the receptors is receptive to light of a different frequency such as red, green and blue light.

The device may comprise a layer of arrays of coupled lenses located over an object.

It is preferred that the device display surface comprises a plurality of icons which are connected to an image means for transmitting an image to the display surface.

It is preferred that the device includes receiver means comprising a plurality of antennas.

The antennas preferably receive and transmit radar frequency electromagnetic magnetic radiation to the coupled lenses.

The receiver means may transmit light or electromagnetic radiation of other frequencies to a transmitter means for transmission to a display means.

It is preferred that the device is able to receive electromagnetic radiation of predetermined frequencies and prevent reflection back to the source, by retransmitting the electromagnetic radiation in a direction away from the source.

The plurality of antennas may comprise a plurality of filaments which are adapted to absorb incident electromagnetic radiation of a predetermined frequency without reflection.

A preferred embodiment of the present invention will now be described by way of example with reference to the accompanying drawings.

According to the preferred embodiment as shown in FIG. 11b pixels are formed by directing light through a coupled pair of lenses 50, 51. Lens 50 is wider in diameter than lens 51 and receives light before lens 51. Each of the lenses is aligned along a common focal axis and is separated from an adjacent pair of lenses by a barrier 52. If the pairs of lenses are too close together an image from one may overlap an image from another lens. This overlapping would degrade any 3D effect produced by light passing through each pair of lenses and striking a display surface 53.

Details of how lenses are arranged to produce a 3D effect is described in PCT application PCT/AU00/01316.

To avoid the degradation in the 3D effect lens pairs may be moved further apart or barrier 52 may be used to separate them from each other.

The provision of pairs of lenses or even additional numbers of lenses which allow passage of light from one to another results in an alteration to the size of the image on the display surface 53. Therefore according to one analogy a wide angle lens could be used in photography. The lens arrangement reduces the size of the image on the surface. In the case of a camera this surface would be the film. Here it would be a film, LCD, CRT or any other emitter or receiver of radiation.

Ideally this system of lenses makes an image as wide as possible without overlapping other lens arrays.

Such lenses may appear as circles or pentagons and other shapes from above or alternatively may be long vertical lines.

In the case of long thin lenses the same principle is employed of restricting the width of the image produced.

In addition the barriers can be used as before to prevent one image from a lens overlapping into a different image of another lens.

The shape of the lens may be variable as long as they are able to display an image. Therefore they could be concave, convex, Fresnel.

According to one example one product by holography makes a surface act in various ways including like a lens.

According to another embodiment of the invention the arrays of lenses may be placed in an emitting system such as an LCD screen. In this case a number of LCD pixels might be under the image area 53 so that when the LCD pixels emit light they shine through the lenses in various directions. Therefore instead of collecting or receiving light the lenses may also act as a way of transmitting or producing light.

The greater the number of sub pixels the more accurate the 3D image. If pixels are long and thin one may increase the resolution in several ways. As an example if there was one long thin pixel which consisted of this system of lenses and it was 768 sub pixels tall, for a 3D effect it would be possible to make four pixels wide. This would be wasteful however as the sub pixels, are four vertical lines of 768 pixels which tells us little information. One answer might be to break up sub pixels to point in more directions.

The principle is to direct sub pixels to more desirable parts of the image received. This can be done in any way, such as, every fourth sub pixel being directed to emit its light into an optic fibre, a tube, or any other apparatus to channel this light. At the end this light would be diffused by various means into a wider surface.

The four sub pixels in this example might be one quarter of the size of the original sub pixel. By reducing the size of the sub pixels the total width of the lens like array might still be the width of an average monitor pixel, say 28 mm. Of course each new smaller sub pixel would emit a quarter of the light so one might increase the brightness four times to compensate.

In this example in which all numbers are arbitrary one might have any sized sub pixel, any number of smaller sub pixels in any orientation and layout. In FIG. 12 an array of 16 sub pixels is shown made from four large sub pixels.

The first sub pixels are in a vertical line E. E1 connects to four other sub pixels F1, F2, F3, F4. E2 connects to G1, G2, G3, G4.

E1 then can illuminate four sub pixels that may be renewable in a given direction or directions. E2, E3 and E4 may with their sub pixels be variable in directions.

E5 might itself connect four sub pixels that are viewable in a given direction and so on. These orientations may be the same in groups of four down the sub pixels or it may vary in any desired pattern.

As an additional example E1 might be directed as follows into F1, F2, F3, F4. This may be a piece of material that tends to diffuse light equally into the four sub pixels.

The material may be such that light stays inside it except for emitting at F1, F2, F3 and F4. This might be because of internal reflection or because its surface stops light from emitting the sides.

Such pieces of material could direct the light into sub pixels as desired then out through either the lens array or other 3D icons such as perhaps in previous applications of PCT application PCT/AU00/01316.

Lenses used in these devices may be differentiated from lenticular lenses. For example lenticular lenses are normally cylindrical and joined together. In these devices the lenses are to be considered as separated in the sense that images from them preferably do not overlap as they do with lenticular lenses. There is a barrier to prevent this overlap which is absent in lenticular lenses. It is preferred that the lenses of the present system focus an image across the whole width between the barriers.

According to another aspect of this invention these devices can also be used with lenticular lenses by placing lenses behind them and barriers between the adjoining lenses.

The lenses described above are also applicable to invisibility devices or cloaking devices. These devices are related to the earlier PCT application PCT/AU00/01316 on 3D imaging.

On the surface of an object it may be desired to make the object appear more transparent. Therefore an array of collectors and emitters of light and radiation which disperse radiation may be provided over the surface so that the radiation strikes one side of the object as if it had passed through the object. An example is given with a plane. These emitters and receptors might preferably be combined into single icons such as an array of lenses as previously described. The surface of the plane might be reflective at certain angles so that light of a certain angle is received into the lens array and greater than this angle is reflected.

Preferably the reflected light contains little or no absorbed frequencies as these may be detected.

All or nearly all possible light should be absorbed by the lenses or reflected at a different angle light that is absorbed in a lens array as previously described would fall upon tubes which collect the image and are connected to converters which convert the collected image into electrical signals. The tubes or similar collect light and other radiation. These tubes may have mirrored inner surfaces and in one embodiment may be connected to optical fibres which enable the light to be transmitted to another surface for transmission.

It may be preferable in some variations to add a material that diffuses light in some tubes, even lenses. It is preferred that the apparatus described above transfers radiation and light as completely as possible. Thus light passing through optical fibres is transferred to another array of lenses on the other side of the plane so that the light ray can exit in a direction which is the same or similar as though it has gone straight through the plane. Conversely a light ray coming from the opposite direction would exit just as the first ray went in.

The principle is that each lens array collects light from various angles and channels them into tubes which transfer light beams to the other side of the plane the light beams exit in the same direction they were going before they encountered the lens giving the impression that the object is invisible. The lenses could be joined together perhaps in a square like or other shaped surface, perhaps with carbon fibre or similar edges around each lens to help absorb radar.

To cover electromagnetic radiation outside the visible light spectrum such as radar, icons may be employed between or inside the lenses. These icons would act as aerials receiving and transmitting for example radar. They would preferably be mirrored on their surfaces so light reflected on them passed through the lenses.

Arrays of these aerials may point in various directions and be connected preferably with aerials on the other side so radar and other radiation is absorbed, transferred in a similar way to the optic fibres.

An example of aerials is shown in FIG. 13 comprising a number of filaments 54 which diverge outwardly from the surface of the object. Radar signals are absorbed in particular aerials in preference to the direction they are coming-from. A signal would be received by the wires 55 connected to the aerials 54 and aerials pointing in similar directions may be connected to wires 56 so a larger wavelength can be absorbed. These wires are connected so on the other side of the plane or any object the waves are transmitted in the direction they were received. The antennas may be in the form of filaments which are like hair covering the entire surface of the object.

Another invention of the present application relates to a method of searching data on the Internet.

At present it is difficult to find useful information on the Internet because unless you know the specific website that needs to be visited the only other viable option is to use search engines which are typically limited to a preferred list of websites. Accordingly searching can become a laborious exercise of searching for the information using one search engine after another until the required information is found.

According to the present invention there is provided a method of recording Internet data comprising the step of providing a server connected to the Internet, receiving a request from a user computer linked to the server to access a website, linking the user computer to the website, recording the data relating to the website including an identifier of the website, storing the data into a first database relating to the request, storing similar data from other requests from any user linked to the server in the first database and producing a list of websites according to the number of times they occur in the first database.

Preferably the list produced orders the websites in order of the number of times they occur in the first database.

The list produced may order the websites according to the number of times the server has been linked to the website.

It is preferred that the identifier includes the name or address of the website visited.

The server may be adapted to receive a request including search data and to link the user computer to a website having the search data.

The first database may include a list of websites containing the search data and the number of times the website has been visited.

Preferably the method includes listing the websites for the first database after a predetermined period of time.

The predetermined time may be once a day or once a week.

Preferably the listing is displayed under a heading including the search data relating to the first database.

The server may include a plurality of databases each for storing the names of websites relating to a particular search data.

It is preferred that the server is a proxy server which is used to access websites whenever a user wishes to access the website.

The server may include an alphabetical listing of subject matter.

It is preferred that the alphabetical listing of subject matter includes internal links to lists of most popular websites to least popular websites in a particular order.

According to another variation of the invention the server is adapted to have a directory database listing websites relevant to a particular subject which is accessed by a user computer.

According to another aspect of the present invention there is provided a computer readable medium having instructions thereon for recording a website identifier of a website visited by a user computer accessing data from the website, a collation means for collating visits to a website having requested data and listing means for providing a list of websites for the requested data, with the websites being listed in order of popularity.

It is preferred that the computer readable medium includes means for setting up a plurality of databases relating to different requested data with each database recording a plurality of websites where the requested data can be obtained and the number of times the websites have been visited.

A preferred embodiment of the present invention will now be described by way of example only.

Because of the problems people have searching for relevant websites for a particular subject matter, the present invention according to the preferred embodiment uses feedback from a searcher to improve future information offered to other searchers.

This is preferably done without invading the privacy of the person who is conducting a search.

Preferably a proxy server is established which acts as an interface between computer users and websites. When someone inputs search criteria such as the name of a famous person a search engine would be employed and the user would access the relevant websites through the proxy server. The proxy server then has a number of databases which it continually adds to whenever a new subject matter for searching is received by a user. Each database is headed by the particular matter such as “Einstein” and each time a searcher visits websites relating to “Einstein” the database adds the name of that website to the database or if it already exists, increments the number of times it has been visited.

Every time someone searches for websites including “Einstein” they will be able to visit the proxy server and use the information in the database headed by the word “Einstein”. Over a period of time such as one day the proxy server will produce a list of the top 10, 50 or 100 websites in order of popularity and this gives the searcher an indication as to which sites might be of most value to access. In this respect the premise is that sites which are visited less often are of less use to people searching for that particular subject.

As the system is used more and more the links and information returned is an average of an algorithm decision based on what links have been most popular. This may be done in many ways with varying amounts of anonymity.

In this example say the inquirer is using an anonymous proxy with cookies disabled, it would not be possible to know who they are and receive no direct information from them.

In this case one encodes the needed feedback in the links presented.

For example if a person inquires with a search term “computing” and the search devices wish to provide links to:

1. computing.com;

2. an article on computing;

3. computer sales;

it offers these links in an encoded form so that they link through a third party. This encoding might contain the search terms, the search date, a number indicating the top 20 links offered and the link chosen. This inquiry comes into devices which record the preferred link, the search terms and the rejected links and forwards the inquirer to this link.

It is preferred that it uses this information to determine the most popular link and may use this to update links to display to various search words and use this survey information for monitoring advertising.

If advertisers or the company wish to find the inquirer they could not, yet in this case they have useful information about them.

If the person being a computer user saves the links then it might be recorded on what dates this link was used, particularly if original data was part of the link. They might use this information again with advertising or just in future response.

It is preferred that the device preferably checks links to see if they are working, non-working links however would rarely be tried by someone so that would tend to be put lower in the list.

In another aspect of the current invention it can be determined how long a user looks at a given web page, whether a web site or a list of sites in a search engine. On receiving a request for a given web page the server may generate a unique identifier for that request, perhaps incorporating the date, the referrer and other information. This identifier may be included in the names of icons on the page such as photos, graphics and flash programs.

Upon the server receiving a request for the web page it also receives requests from the user for the given photos and other icons on the web page, and commences transferring them to the user. It then monitors the time it takes for these icons to download on the basis that when the user moves to another web page the downloads may be interrupted. Therefore the server knows how long the user looked at the web page and may thereby determine how interesting it was, perhaps from the viewpoint of the advertisers.

In another embodiment an advertisement may contain sections that download at different rates so that it can be determined if users wait for all or part of the advertisements for example, and hence if they are reading them. Text may also be in a graphic and so it can be determined if users wait for the full download to read all a given text.

The above principle is equally applicable to computer related structures which are part of a network where it is desirable to assemble information according to feedback from people or other computers.

Another aspect of the present invention relates to systems for compressing data.

The system is particularly concerned with compression of data for transmission over a communication line.

According to the present invention there is provided a system for compressing data comprising a receiver means for receiving original data over a predetermined period of time, first processing means for identifying data which is substantially the same over the predetermined period of time and producing this data as constant data, difference means for identifying data which changes over a predetermined time interval less than the predetermined period of time and producing this data as difference data, transmission means for transmitting the difference data whereby a second receiver is able to receive the difference data over a plurality of time intervals and a second processing means is adapted to add each time interval of difference data to missing data to form the original data over the predetermined period of time.

Preferably the transmission means is adapted to transmit the constant data.

The missing data preferably includes constant data.

The missing data may include data which is estimated to “fill in” gaps in the difference data.

It is preferred that the system includes the second receiver and second processor.

The second processor may be adapted to store constant data for the period of time and add part of this data corresponding to the time interval to the difference data over the same time interval.

It is preferred that the second processor is adapted to add successive time intervals of constant data to corresponding successive time intervals of difference data over a preset time period.

The system may include algorithm means for adding constant data to difference data.

Preferably the algorithm means includes at least one algorithm for deciding where portions of data within the constant data need to be added to the difference data.

It is preferred that the algorithm means includes intelligence processor means which is adapted to calculate where missing data needs to be added to the difference data.

The intelligence processing means may include modelling means for modelling where missing data needs to be added to difference data based on historical data relating to similar subject matter to which the data relates.

It is preferred that the system includes a database of models relating to different subject matters.

The system may include a selecting model which best fits subject matter of data being transmitted and is able to reproduce it when received at a remote location.

According to one form of the invention the data comprises speech.

According to another aspect of the present invention there is provided a method of modelling data including the steps of storing a plurality of spoken sound generator types in a first memory, storing a plurality of different spoken sounds in a second memory, identifying which spoken sound generators are required to produce a different spoken sound and storing those spoken sound generators in a first modelling algorithm memory together with the spoken sound they are able to produce, identifying what actions are required of each of the spoken sound generators in order to produce the different spoken sounds and storing the actions in a second modelling algorithm memory together with the associated spoken sounds they produce and forming a spoken sound database including a plurality of sound generator models comprising a combination of the data from the first and second modelling algorithm memory for each spoken sound, whereby a database of spoken sounds is able to be produced together with the sound generators and actions required to produce each spoken sound.

It is preferred that the spoken sound generators include or model parts of the human body for producing sound, such as the tongue, voice box, mouth, lips, lungs, size of mouth and throat, etc.

It is preferred that the method includes the step of receiving a spoken sound and processing the spoken sound into electrical signals and retrieving from memory the corresponding spoken sound form from the spoken sound database.

It is preferred that the method includes the step of mimicking the received spoken sound by using a mimicking means which utilises data stored in the spoken sound generator.

It is preferred that the method includes outputting the written form of the spoken sound on a display.

The system may include a receiver means for receiving speech and outputting text to the display.

The system may include a translator means for matching the electrical form of each sound received with the spoken sound generator models and outputting the corresponding text.

According to another aspect of the present invention there is provided a method of modelling speech data including the steps of providing a receiver comprising a transducer for converting spoken sounds into electrical signals, receiving a spoken sound, converting the spoken sound into electrical signals, providing a mimicking means, using the mimicking means to mimic the electrical signals representing the spoken sound and storing the mimicked version of the electrical signals in a mimic database.

Preferably the method includes the step of forming a database of spoken sounds produced by the mimicking means.

It is preferred that the method includes the step of providing a database of written text which has text therein corresponding to spoken sounds stored in the spoken sound database.

Preferred embodiments of the present invention will now be described by way of example only.

The primary principle of this invention is that of compressing data by modelling part of the data and adding additional information to create the original or near original data.

As an example to create a file with loss less or near loss less compression it is desired to make a compressed version of the file, e.g. JPEG, WAVELETS, modelling animated or structured data such as a cartoon, or art like representation of the files and then making another file which contains that and the difference information between that and the original or near original.

According to one example a video image would be transmitted from one location to another by firstly storing JPEG like files and comparing adjacent JPEG files to the original images so as to create difference files which include the differences between consecutive files. These difference files are the differences of each frame to the original image as well as the differences to each other. Jpeg and other lossy compression is an approximation to the original frame images so the difference data can be transmitted so the receiver adds it to each frame data to give the original data or a desired approximation of it. Therefore instead of sending each frame of the original data, only the differences between consecutive or adjacent frames would be sent and a JPEG like file would be used to add in the missing data at the receiver end of the system. If certain parts of the images of the video did not change from frame to frame then the JPEG file would be useful in adding in the unchanged information to recreate the original data. Thus effectively the data transmission would be reduced because only the difference data would be transmitted.

According to another example an animated version of a scene would be produced such as that in a game. This animated data would be constantly added to difference data over a period of time, but because the animated data was predetermined as to its nature this could be stored at the location where the difference data would be added to it to recreate the original data.

In another aspect of the present invention in the game Quake there are animated figures. If one figure was designed to be very similar to a person to be imaged and transmitted then by transmitting controller information on how to move this animated figure in a similar way to the real person a good approximation of that person's movements and appearance could be sent. By then adding the difference data between this animated figure and the images of the original person a close representation of the original would be obtained.

A preferred embodiment would be a figure or figures reading news for example in an Internet broadcast. The receiver downloads the animated figure that approximates the newsreader. According to one aspect graphic accelerator cards may smooth out and enhance this modelled figure as in Direct 3D for example. Difference data is transmitted and added to this figure giving a good approximation of the original figure reading the news but at a lower bandwidth.

According to another example a video image would be broken into an animated version of the image as well as the differences between the animated version and the original.

The animated version may be a standard animation which would be held at a receiver so that only the difference data would need to be transmitted.

According to a further example it would be possible to employ various kinds of mapping between different frames so that the video appears smoother or more distorted. By adding difference data the image can be changed to correct this as desired.

According to another aspect of the present invention one can remove some frames of a transmission and by morphing algorithms obtain an approximation of those frames. For example one sees in morphing where a person may change from an animal to a person. A good example of this is in the movie Harry Potter where Professor McGonagall changes from a cat into a person. The intermediate frames between the cat and person images are created by morphing programs.

In a similar way by removing some frames in a transmission one can use this morphing to recreate the missing frames though these frames will usually not be a completely accurate replacement. By then adding the difference data to make these morphed frames similar to the frames removed one can recreate the missing frames. This difference data is transmitted and morphing means at the receiver can recreate the missing frames.

According to another aspect of the present invention dynamic data can also be used with a model and difference data. For example if there is a computer program similar to a desired one then one can add difference data between that and the desired program perhaps as the desired program runs.

According to a different embodiment of the invention there may be a program for performing an action, for example moving robotic parts. This program may not act completely as desired or it may be desirable to tailor it for another purpose. By adding difference data between that and the desired actions one can make this program do the task instead of having to rewrite the program.

According to a different embodiment of the invention relating to text, it is possible to remove some grammatical information from data, for example the word “the” might be removed as it might be obvious that such a word would normally be found in the text. In another example where a sentence defines for example future tense, simple present tense versions of words could be substituted. In this case the difference data may be algorithms to restore it to the original or other as desired. In another example the word “the” might occur many times in a text and where it could be inferred it should appear once it has been removed. Therefore an algorithm would be used to remove text which could be easily added once the compressed form of the overall text had been transmitted to a receiver.

With the above example an artificial intelligence like program or set of rules could be established which would be able to work out what data had been removed from the difference data and therefore what this data is and where it should be reinserted in the original data. Using the text example a set of rules could be established which could be relied upon to work out where missing text should occur in for example a statement.

According to a further example programs such as grammar and spelling checkers could be known to suggest certain alterations to a text. By knowing what these suggestions are in advance one can delete or change certain information and words as these checkers will restore these alterations at the receiver's end. If the checkers are known to suggest various alternatives one then sends which alternatives are to be chosen.

According to a further example it would be possible to have various buildings and trees in scenes and one could strip them but with the understanding that a building disappearing is an indication for a reproduction of it to be reinserted and difference data or algorithms applied.

In a video faces of people may be removed with the sense that they can be recreated in a known way from estimates that the intelligence programs would utilise so that again only difference data needs to be transmitted.

With regard to another embodiment of the invention search patterns are employed to try different compression and modelling ideas with difference data to see which ones are the most effective. For example with speech recognition various voice boxes and other parts of the body are modelled so that one can accurately if desired reproduce a given persons voice or types of voices and what difference data or algorithms are required to change this to others voices.

By creating a database of these types of accents, etc. it is possible to input some speech and one is able to determine what modelled body part (voice boxes, mouth, etc.) and accents (e.g. Californian style speech) may reproduce it and what differences (data) or algorithms can be added (when difference data is referred to this includes algorithms).

The difference data then gives a guide as to how accurate the model is. When interpreting text the model selects various vocal chord, tongue, mouth, etc. movements that give a close sound to that heard in the text and such movements are then associated with words spoken.

In the above manner it is possible to produce text from spoken sounds by first mimicking the sound using an appropriate electrical system and matching the mimicked sound with a database which has previously been created. This database would have many spoken sounds and their corresponding text. The database would have been created by making the mimicking device create numerous spoken sounds so that they could be stored in a text form. Therefore once the device has mimicked an existing spoken sound all that is required is for the database to be checked for the most similar previously spoken sound by the mimicking device.

With the above system it would be less likely to introduce some errors as a word spoken and related to one model is unlikely to be referenced against a model of a different person type. Therefore the database could end up being quite extensive and algorithms could be used to establish whether any text change is necessary if a mimicked spoken sound is not exactly the same as that stored in the database. Thus when a word sounds like one thing in the selected model and another word in a different model the selected model could probably prevail.

As an example speech recognition programs often make mistakes with spoken words. A person may say “cap” and the program interprets this as “cat”. With these devices under one embodiment the program creates a model according to how a person talks by simulating how their vocal cords, tongue, lips, etc form words. This is similar to how some music synthesizers recreate a saxophone sound for example by modelling the shape of the saxophone and its acoustics.

It may also do this by emulating how they form vowels, consonants, and diphthongs. When a person then says “cap” it finds that when it emulates the word “cap” that this sound waveform is most similar to the spoken “cap” and that it cannot emulate the word “cat” to sound like “cap”. This is because when it makes a “up” sound and a “t” sound they are distinct and its “p” sound fits the spoken data better. To use an analogy a person cannot usually make a “p” sound and make it sound like a “t” sound, so the devices are unlikely to model a word sound incorrectly.

In another aspect of the current invention the devices may alter the frequency and length of a sound it generates to make it more similar to the spoken word. For example when a person says “cap” they may say it as a question, quickly and in a high pitched way. The devices mimic this word by raising the frequency at the end of the word and shortening it. They then compare the mimicked sounds to see which ones fit the spoken words best.

Difference data would allow the model to be less complex and easier to use and of course difference data can at any time be analysed for additional modelling and compression.

According to another aspect of the invention difference data may be used in a network of computers. Preferably this network would include the Internet. Data is searched to look for similar parts, such as for example attachments, text and code. In the case of attachments these devices may search attachments in email going through a node of the network to look for similarities. An example of this node would be the Internet Service Provider. Worms, spam and viruses can often be similar in composition so a searching means such as a checksum of parts of data can identify parts of different emails that are substantially the same and flag these as possible viruses or spam. It may then withhold them or place them in a different location such as a special folder.

According to another example a dictionary of algorithms could be produced. Thus where as in compression dictionaries of phrases are often employed, of terms found many times in a given text, a dictionary of algorithms is a list of algorithms that can be used in a text substituted or represented by for example a symbol.

A given word may have several anagrams such as BCAT, BETA, ABET and these might under a pre-agreed or other arrangement be denoted in a given order. This may be as an example the order they would occur in a given dictionary. When one of these words appears a symbol plus a number may denote the word and the number which anagram it is. As example BETA may be substituted by a symbol representing all anagrams and a number denoting which anagram it would be, the third in this case.

In another example normally a dictionary contains phrases commonly found in the text or image. In this case the dictionary contains phrases closest to or related in some way to commonly found aspects in the text plus algorithms as to how they should be applied.

In one way phrases close to terms found in the text are put in the for example dictionary with introductions that in the text a symbol or symbols will be substituted for that phrase plus or minus the difference data to make it the same as the text phrase. As an example if 20, 19, 18, 21, . . . are found in the text a phrase 19 may be placed in the dictionary and as a symbol in the text so it appears as +1,*,*−1,*+2, . . . Other parts may be related by a formula to this phrase such as 2*+2. * being 19. In this way approximate dictionary entries plus difference data represent the original or other, such as other perhaps related text like related video frames, related spread sheets, etc.

This is differentiated from a dictionary of phrases used in compression. In the currently used system the programs scan for particular common icons such as words in a text. They then by various means such as Huffman trees work out how to replace the most common words in the text with the smallest symbols. For example “the” might be the most common word in a text and so one would replace this with the smallest symbol which makes the text smaller in size overall.

A dictionary of algorithms then is not a list of icons appearing in a text or any data such as images and programs but a way of putting a symbol in the data saying to perform an action on data. Such an action may be to add difference data or any other action. Say for example the word “the” is common in a text and so is the word “and” One might then subtract the number of characters required to transform “and” into “the” and then use the same symbol for both words but add on the difference data. For example “*” might be used to replace “and” and “*19-6 1” as “the”.

In this example instead of being confined to a dictionary of phrases one can have a dictionary of approximate phrases to those found in the text.

According to a further invention of the present application a new device is provided for processing data.

In a particular form the device relates to a new way of categorising logical operations such as those carried out by computer hardware.

According to the present invention a device is provided for processing data comprising an input, a processor, and an output, wherein the processor is adapted to receive data at the input and process the data according to one of a plurality of predetermined options and generate the option at the output wherein the predetermined options include the input is true, not false, false, not true, not true and not false.

It is preferred that the options include one or more of the following possibilities; possible, probable, can, won't, can't and/or won't, can't and will, unlikely.

Preferably the input includes at least two inputs and the processor is adapted to compare the inputs and output a signal representing at least one of the options.

Preferably the output is adapted to generate a plurality of different options.

Preferably the output includes a plurality of output ports.

The processor may use Boolean operations to process input data.

The processor may include a look up table means and comparison means for comparing input data with the options available in the look-up table means and outputting a signal representing one or more of the options which is applicable.

Preferably each option is represented by a different electrical number such as a voltage level or combination of logical zeroes and ones, i.e. digitally.

It is preferred that the output includes a plurality of different outputs each representing a different option.

According to the preferred embodiment of this invention a device is provided which uses criteria other than the traditional true or false or combinations thereof to perform logical Boolean operations. By using different terms in accordance with the present invention it is possible to control circuits to explore tasks more easily than they may have been performed using pure Boolean algebra.

As an example there are the terms not true in place or false and not false in place of true. The theory behind providing options in this converse manner is that an answer to a question can be given in terms other than black or white. Therefore options are created for covering things that are not black or white, but instead are shades of grey.

Therefore considering as an example the paradox, “this statement is false” can be regarded as not false because it is asserting a fact and yet not true because it asserts that it is false. Hence in a program it can be referred as not true and/or not false. Whereas true or false both fail to describe it.

In another embodiment irrational numbers can be referred to as not odd or not even so that they can be represented digitally.

It is also possible to use “not yes” and “not no” and in this manner build a mathematically sound way to refer to objects and operations by what they are not.

In another example, while yes/no and true/false are static expressions, will/will not and can/cannot are dynamic in that they refer to actions. These can be used in formula like Boolean algebra to ascertain what is possible or probable rather than what is true. This can also be set as will/cannot and can/will not. Thus possible logical operations are set out below:

a—true; b—not false; c—not true and not false; d—not true, e—false; f—can; g—will not; h—cannot and/or will not; i—cannot; j—will.

Using the above theory a program may be set to explore what it can do (can) but not to do it (will not) or things to do (will), but its failures (cannot) are also catalogued. In this way in setting a task a computer may quickly work out if it can do something or not.

The principle “cannot” and “will not” is referred to as the coordinator and the not true and not false as the expert. In other words the coordinator is a body of knowledge that does not do anything in some ways because it is knowledge or what it cannot or will not do.

Increasing this knowledge allows the system to work on the “can” and “will” parts of the knowledge.

The expert is also a body of knowledge as while the excluded middle is useful in logic many real problems reside in the shades of grey not black/white. Answers to problems in this expert section can be much more detailed and valid but still be logically consistent through its being set as operations in algebra and hence for all of these in hardware/software and any other physical representation of the statements.

A further invention in accordance with the present invention relates to vehicles and in particular to the protection of vehicles involved in accidents.

Vehicles today are typically made with a structure which allows absorption of an impact when the vehicle is involved in a collision.

The present invention provides an alternative to these systems.

According to the present invention there is provided a device for vehicles comprising an urging means connectable to a vehicle, which is adapted to apply a force to an object impacting on the vehicle to which the device is connected.

Preferably the urging means includes a resiliently deformable member.

It is preferred that the device includes a front member which is adapted to receive an impact. The urging means may be located behind the front member.

It is preferred that the urging means comprises at least one spring.

According to an alternative embodiment the urging means includes a plurality of springs.

Preferably the device includes aligning means for aligning the urging means to receive an impact at a front end thereof.

The device may include side members which retain the front member in a substantially front facing orientation.

Preferably the side members are adapted to maintain the front member in an orientation where the urging means includes urging members which are adapted to be oriented in a substantially parallel direction normal to the transverse direction of the front member.

The side members may include slots which receive ends of the front member.

The front member is preferably an elongate member which extends across the urging members.

The device may include a transfer means for transferring impact on the front member to an opposite part of the vehicle.

The device preferably includes front and rear members each connected to the transfer means.

The transfer means may include the urging means.

It is preferred that the transfer means includes elongate members adapted to extend between opposite ends or sides of the vehicle.

Preferably the elongate members extend in parallel along a longitudinal axis.

It is preferred that the device includes first and second urging members separated by the transfer means.

The device may include front and rear members connected respectively to front and rear urging members.

A preferred embodiment of the present invention will now be described by way of example only with reference to the accompanying drawings in which:

FIG. 14 shows a side view of a schematic of a vehicle including a device for resisting impacts in accordance with a preferred embodiment of the present invention;

FIG. 15 shows a schematical view of the device shown in FIG. 14;

FIG. 16 shows a further embodiment of the device shown in FIG. 15; and

FIG. 17 shows an additional embodiment of the device shown in FIG. 16.

In order to reduce damage to a vehicle a device is described which when triggered applies an opposing force to the impacting force on the vehicle. Thus as shown in FIG. 14 a vehicle 60 is provided with a device 61 for triggering an opposing force to an impact. This device is located between the cabin 62 and the engine 63.

Typically the device 61 includes springs which push against the force applied by an obstacle 64 when the vehicle hits it. Without the device 61 the vehicle when striking the obstacle 64 would result in the engine 63 being pushed back into the cabin 62. As shown more clearly in FIG. 15 the device 61 includes a front member 65 which extends from one side of the vehicle to the other and is connected to a similar transverse member 66 through three springs 67.

Thus with the device in place as the engine 63 moves towards the cabin, during a collision with the obstacle 64, the device 61 applies a force against the engine so as to move it in the opposite direction. The extent to which the engine moves in the opposite direction or is reduced in momentum depends upon the force applied by the springs.

As shown in FIG. 16, the front member 65 is held within recesses 68, 69 provided in side members extending forwardly or rearward member 66. The side members 68 ensure that any impact on member 65 helps keep the member 65 in alignment so that as much of the impact force as possible is applied directly through the spring 67. Clearly if the force was applied transverse to the springs then they would have little effect on the impact.

The spring shown in 67 can equally be replaced by other forces or devices which are able to apply an opposing outward movement. Examples are explosives, compressed gas, other chemical reactions etc.

The device may also be set up as either a passive or active apparatus. In a passive form the device would merely react to an impact by initially storing energy and then returning that energy by pushing against the impact force. Alternatively a triggering device may be incorporated to trigger the reactive force from the device as soon as an impact is sensed.

According to another example the triggering device may include a seal which is broken on a cylinder containing compressed gas. A sensor could be a visible sensor or strain gauge type sensor or any other suitable device.

The device may provide repulsive force by utilising magnetic fields and the force generated thereby. Therefore the forward and rear members 65 and 66 may be repelling magnets which upon triggering releases the forward magnet to move away from the rear magnet.

The device is also applicable to other vehicles such as boats, car doors, struts, aircraft panels and armory etc. In this way a device may be a way of storing energy and releasing this energy upon sensing a particular occurrence.

As shown in FIG. 17 according to another embodiment the device may be modified so that it is able to transfer force from one part of a vehicle to another thus the device would include a front part 69 and a rear part 70. Both the front and rear parts 69, 70 would be interconnected by struts 71, 78 which extend down each side of a vehicle. Each of the devices 69, 70 would operate according to any one of the previous embodiment and apply a repulsive force to any impacting object. A force the would then be transmitted by the struts 71, 72 to the opposite device at the other side/end of the vehicle. In this embodiment it is therefore possible to combine the useful aspects of repelling the force as well as transferring any force which is still received by the vehicle.

Another aspect of the invention refers to the movement of objects by interior forces such as magnetic field for their precise movement in a space. By manipulating these forces the objects may be moved around for various tasks One example here is for moving devices inside a volume of material, e.g. a body.

Such devices may consist of material capable of being moved by these forces, e.g. material attracted by magnets. These devices may include other tools for performing operations such as cutting, disecting etc. As examples the objects may contain input devices such as cameras, temperature and pressure sensors, even biological compounds that react in the presence of bacteria, cancer cells etc. Such compounds may be employed by devices to release medicines, toxins (to kill e.g. cancer calls), take samples, etc. The objects may be designed to heat or cool to impact their environment e.g. to cauterise or kill cells.

Knife like devices and sharp edges may allow these devices to cut through material, e.g. body tissue for movement and heat to cauterise its passage.

The objects may have internal power or be drawn from outside.

In this examples surfaces of various shapes surrounding the subject C (in this case a person with devices B acting as magnets e.g. electromagnets coupled with other sensors etc. e.g. ultrasound, x-rays, cat scan etc. In this case an object E has been inserted that is attracted by magnets. It may contain all the devices referred to earlier, e.g. cameras, knives, etc.

By manipulating the electromagnets B the object E can be moved around inside the body by pulling on it, from various directions. Such attraction may be continuous or of various strengths and in pulses. In this way E is moved to the desired areas, e.g. a tumour. It may move by cuttings its way through such as having sharp knives on its exterior.

F are e.g. sharp blades or spikes to cut through e.g. tissue.

On arriving at its destination E may be e.g. moved so as to cut up the tumour. In another example, pulsating magnetic fields may cause it to vibrate and even heat up to kill cells with heat. Of course E may do anything, e.g. deliver medicine by other inputs working machinery inside it e.g. nano machinery.

In another example E might be manoeuvred in blood vessels to wear down deposits of cholesterol or observe various aspects of the body. It might unclog blocked vessels.

In other examples of the general principles objects such as E might be used to examine and interact with inorganic objects. For example in nonmagnetic materials E, might be manipulated e.g. copper aluminium etc.

In another aspect of the present invention the attractive and repulsive forces of magnets may be employed to do work. Using their motion towards and away from each other this can be connected to gearing, levers, flywheels and any other machinery. This motion can then turn gears and for example turn motors and generators creating movement and generating electricity.

It is to be understood that, if any prior art publication is referred to herein, such reference does not constitute an admission that the publication forms a part of the common general knowledge in the art, in Australia or in any other country.

1. A device for a stringed instrument comprising at least one moveable support having a top surface which is adapted to abut a string between its fixed ends and is able to be moved to abut the string at a different position to thereby create a sound of a different frequency when the string is vibrated.

2. The device as claimed in claim 1 wherein the moveable support is able to move the top surface to a different position along the length of the string.

3. The device as claimed in claim 2 wherein the support top surface has a plurality of abutment surfaces each adapted to abut a string at a different position along its length.

4. The device as claimed in claim 1 or 2 including a control means for controlling where the top surface abuts the string along its length.

5. The device as claimed in claim 4 wherein the control means comprises a lever operable by a finger.

6. The device as claimed in claim 4 wherein the control means comprises a sliding means which is adapted to slide the top surface forward or backward along part of the length of the string.

7. The device as claimed in claim 4 wherein the control means comprises pivot means which is adapted to pivot the top surface whereby a different abutment surface is able to abut the string.

8. The device as claimed in claim 4 wherein the control means comprises an urging means for urging an abutment surface into contact with the string.

9. A device as claimed in claim 4 wherein the urging means comprises a plurality of springs adapted to urge a different abutment surface into contact with the string.

10. The device as claimed in claim 1 wherein the control means includes a different control member for each abutment surface, whereby each control member can be operated to raise or lower the abutment surface into or out of contact with the string.

11. The device as claimed in claim 10 wherein the abutment surface comprises a moveable fret.

12. The device as claimed in claim 1 comprising a base which is adapted to be attached to a neck of a stringed instrument.

13. The device as claimed in claim 1 including a sleeve with a plurality of supports extending upwardly from a top surface of the base.

14. The device as claimed in claim 1 including buttons to move each abutment surface.

15. The device as claimed in claim 14 including pressurised areas which when individually depressed are adapted to move at least one abutment surface.
